(19) United States
(12) Patent Application Publication
(10) Pub. No.: US 2023/0373824 A1
(43) Pub. Date: Nov. 23, 2023

(54) Destruction of Perfluorosulfonic Acids (PFSAs) via Supercritical Water Oxidation

(71) Applicant: Revive Environmental Technology, LLC, Columbus, OH (US)

(72) Inventors: Christopher Scheitlin, Columbus, OH (US); Kavitha Dasu, Powell, OH (US); Stephen H. Rosansky, Tampa, FL (US); Julia Stowe, Honolulu, HI (US)

(21) Appl. No.: 18/200,506

(22) Filed: May 22, 2023

Related U.S. Application Data
(60) Provisional application No. 63/344,546, filed on May 21, 2022.

(51) Int. Cl. C02F 1/72; C02F 11/08

(52) U.S. Cl. CPC C02F 1/722; C02F 11/086; C02F 2101/36

(57) ABSTRACT

Supercritical water oxidation (SCWO) is a destruction technology to quickly treat per- and polyfluoroalkyl substance (PFAS)-impacted groundwater, investigation derived waste, and other aqueous matrices such as landfill leachate and aqueous film forming foam. Laboratory-prepared and field-collected samples with inlet PFAS concentrations up to 50 parts per million were consistently destroyed to less than 70 parts per trillion for all PFAS, when running at the determined optimal operating conditions (≥600° C. and 3,500 pounds per square inch). We investigated the correlation between temperature and flowrate of the system, finding that reactor temperatures ≥450° C. destroys perfluorinated carbonic acids, but higher temperatures and specified conditions are necessary to destroy perfluorosulfonic acids. Using a higher density oxygen source also increases the throughput of a SCWO reactor, here up to 140 mL/min, without affecting PFAS destruction. Continuous 5-log reduction in the concentration of PFAS (99.999% destruction) is demonstrated for 3 hours at steady-state operation. The destruction efficiency is not impacted by the addition of co-contaminants such as petroleum and other organic hydrocarbons, and the SCWO process is successfully applied to waste streams without pretreatment. The treated effluent is largely comprised of complete combustion products including carbon dioxide, water, and the corresponding anion acids; hence, the treated liquid can be released back into the environment after neutralization.

### RELATED APPLICATIONS

This application claims priority to U.S. Provisional Patent Application Ser. No. 63/344,546 filed 21 May 2022.

### INTRODUCTION

Per- and polyfluoroalkyl substances (PFAS), including perfluorooctane sulfonate (PFOS) and perlluorooctanoic acid (PFOA), and hundreds of other similar compounds, have been widely used in the United States in a multitude of applications. There are significant concerns associated with these compounds due to widespread contamination coupled with uncertainties about risks to human health and the environment. PFAS are molecules having chains of carbon atoms surrounded by fluorine atoms. The C—F bond is very stable enabling the compounds to persist in the natural environment. Some PFAS include hydrogen, oxygen, sulfur, phosphorus, and/or nitrogen atoms. One example is PFOS:

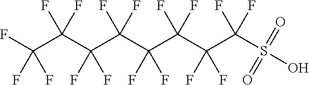 [SMILES: O=S(=O)(O)C(F)(F)C(F)(F)C(F)(F)C(F)(F)C(F)(F)C(F)(F)C(F)(F)C(F)(F)F]

Although some PFAS compounds with known human health risks have been voluntarily phased out (PFOA and PFOS), legacy contamination remains. Replacement PFAS compounds have been introduced with limited understanding of their health risks. PFAS contamination in drinking water sources in 1,582 locations in 49 states as of May 2020. Currently used techniques for treating PFAS-contaminated water are expensive, and management of spent media is costly and may result in long-term liability.

Recently, the EPA proposed to designate PFOA and PFOS, including their salts and structural isomers, as hazardous substances under the Comprehensive Environmental Response, Compensation, and Liability Act (CERCLA) to facilitate cleanup of contaminated sites and to reduce human exposure to these chemicals¹. To meet this goal, studies have evaluated a variety of conventional and advanced technologies for PFAS removal from and/or degradation in water.

Conventional remediation techniques, such as oxidation using peroxide or persulfate and bioremediation, have had limited effectiveness²⁻¹. Application of conventional granular activated carbon adsorption and ion exchange resin are a challenge due to differing chemical and physical properties of distinct PFAS, as shorter chain PFAS tend to break through faster which necessitates the faster change out or regeneration of the sorbents⁷. Several effective PFAS treatment methods are being developed, but most have only been tested at the laboratory scale with few field applications⁸. Some technologies under development include sorption using carbon-based materials (biochars and nanotubes) and/or other novel sorbents, removal by ion exchange, advanced oxidation processes (AOPs—electrochemical oxidation, photolysis, photocatalysis, activated persulfate oxidation, and ultraviolet [UV]-induced oxidation), advanced reduction processes (ARPs—potassium iodide [KI] combined with UV), thermal (thermal chemical reaction, microwave hydrothermal, and incineration), chemical/electrical treatment (sonochemistry, electrical discharge plasma, and high-voltage electric discharge), and microbial treatments^{5, 9-20}. Many of these technologies have been shown to produce short-chain PFAS as byproducts or exhibit selective destruction of only perfluorinated carboxylates (PFCAs) and partial mineralization of perfluorinated sulfonates (PFSAs)^{14,15,21,22}. Reductive methods reported in the literature for the destruction of PFAS have shown to follow defluorination mechanisms by the cleavage of carbon-fluoride bonds. Due to the high reduction potential of hydrated electrons (−2.9V), reductive defluorination involving hydrated electrons has been shown to be effective for PFAS destruction²³⁻²⁶. Reductive methods have been shown to be generally more efficient than oxidative methods, requiring very little energy to initiate breakage of the carbon-fluoride bond.

This efficiency makes reductive methods attractive compared to energy intensive oxidative methods such as SCWO; however, reductive methods are not consistently showing degradation of all PFAS compounds to ppt concentrations^{27,28}. Degradation was slow and incomplete for perfluorinated sulfonates (PFHxS and PFOS), and most of these reported methods are laboratory scale with many limitations to the full-scale application of these processes. Hydrated electrons are short lived and require anoxic conditions. The presence of oxygen and water chemistry (bicarbonates, nitrates, chloride ions, and humic acids) in environmental aqueous matrices quenches the hydrated electrons generated, hence results in suppression of PFAS destruction^{23,27-29}. Recent interim guidance released by the U.S. EPA for the planned research and development on destruction and disposal technologies for PFAS and PFAS-containing materials mentions supercritical water oxidation (SCWO) as one of the promising innovative technologies for the destruction of PFAS in AFFF³⁰.

SCWO involves oxidation of aqueous organic compounds at temperatures and pressures above the critical point of water in the presence of oxygen^{31,32}. This technology has shown rapid and near-complete destruction of several recalcitrant organic contaminants including polychlorinated biphenyls, radioactive waste, and certain nerve agents³³⁻³⁵ The SCWO process involves reacting the dissolved organic contaminant with an oxidant in water at a temperature and pressure above the supercritical point of water (374° C. and 3,205 pounds per square inch [psi]). At these conditions, the water and organics become miscible and form a uniform homogeneous mixture, which results in changes in their properties and provides a single fluid phase of a water-oxygen-organic mixture. The reaction of organic molecules with oxygen generates environmentally benign end products, such as water, carbon dioxide, and inorganic salts³⁶. These benefits promote SCWO as a promising technology to treat PFAS despite the unique chemical and physical properties of these compounds^{35,37}. SCWO is an energy intensive process which operates at high temperature and high pressure. Continuous operation under high oxidizing conditions poses challenges such as salt plugging and corrosion of the reactor construction materials. However, these challenges can be managed by taking special consideration while choosing the construction materials capable of withstanding oxidizing environments to mitigate corrosion and special reactor designs to handle the salt formation and prevent salt plugging³⁸. The continued development of effective technologies, such as SCWO, for the complete destruction of PFAS is critical to meet the recent U.S. EPA guidance and state regulations³⁰.

Numerous methods have been developed for remediating PFAS in the environment. For example, Oberle et al. in US 2019/0314876 describes a method and system for remediating soil containing PFAS in which the soil is heated and the PFAS volatilized, captured and condensed, steam added, and then the concentrated PFAS solution subjected to electro oxidation. A review of some recent demonstrations of SCWO is provided by Kraus et al. in “Supercritical water oxidation as an innovative technology for PFAS destruction,” J. Environ. Eng. 148 (2022).

Application of SCWO to PFAS is relatively new and presents new challenges. SCWO of organic compounds has long been known and is described in numerous papers and patents. For example, Welch et al. in U.S. Pat. No. 4,861,497 described the use of a liquid phase oxidant such as hydrogen peroxide or ozone in supercritical water for the destruction of organic compounds; testing with destruction of propylene glycol at 750 to 860° F. at 5000 psia (pounds per square inch atmospheric) resulted in about 98% destruction. Swallow et al. in U.S. Pat. No. 5,232,604 described SCWO of organic compounds with an oxidant such as hydrogen peroxide and a reaction rate enhancer such as nitric oxide; in one example, sodium hydroxide and sodium nitrate were used to neutralize hydrochloric acid formed in the oxidation of methylene chloride. Aquarden Technologies in US Published Patent Application No. 2019/0185361 notes that in the SCWO process precipitation occurs in a zone where the fluid goes from sub-critical to super-critical and designed a reactor with a residue outlet connection near this zone. Miller et al. in “Supercritical water oxidation of a model fecal sludge with the use of a co-fuel” Chemosphere 141 (2015) 189-196 reported on the SCWO reaction of a feces simulant in the presence of 48% excess oxygen. The use of auxiliary fuels can be used to generate hydrothermal flames in SCWO reactors that are characterized by high temperatures, typically above 1000° C. See “Supercritical Water Oxidation,” in Advanced Oxidation Processes for Wastewater Treatment,” (2018), 333-353 and Serikawa et al., “Hydrothermal flames in supercritical water oxidation: investigation in a pilot scale continuous reactor,” Fuel 1147-1159 (2002).

Despite extensive prior efforts to develop systems for destroying PFAS, there remains a need for efficient systems for treating PFAS compositions and the complete destruction of PFAS.

### REFERENCES

1 US EPA. 40 CFR Part 302. EPA-HQ-OLEM-2019-0341. Designation of Perfluorooctanoic Acid (PFOA) and Perfluorooctane Sulfonic Acid (PFOS) as CERCLA Hazardous Substances. (2022).
2 Deng, S., Zhou, Q., Yu, G., Huang, J. & Fan, Q. Removal of perfluorooctanoate from surface water by polyaluminium chloride coagulation. Water research 45, 1774-1780 (2011).
3 Takagi, S. et al. Fate of Perfluorooctanesulfonate and perfluorooctanoate in drinking water treatment processes. Water Research 45, 3925-3932, doi: 10.1016/j.watres.2011.04.052 (2011).
4 Xiao, F., Simcik, M. F. & Gulliver, J. S. Mechanisms for removal of perfluorooctane sulfonate (PFOS) and perfluorooctanoate (PFOA) from drinking water by conventional and enhanced coagulation. Water research 47, 49-56 (2013).
5. Merino, N. et al. Degradation and Removal Methods for Perfluoroalkyl and Polyfluoroalkyl Substances in Water. Environmental Engineering Science 33, 615-649 (2016).
6 Rayne, S. & Forest, K. Perfluoroalkyl sulfonic and carboxylic acids: a critical review of physicochemical properties, levels and patterns in waters and wastewaters, and treatment methods. J Environ Sci Health A Tox Hazard Subst Environ Eng 44, 1145-1199, doi:10.1080/10934520903139811 (2009).
7 Shahsavari, E. et al. Challenges and Current Status of the Biological Treatment of PFAS-Contaminated Soils. Front Bioeng Biotechnol 8, 602040, doi: 10.3389/fbioe.2020.602040 (2020).
8 Gagliano, E., Sgroi, M., Falciglia, P. P., Vagliasindi, F. G. A. & Roccaro, P. Removal of poly- and perfluoroalkyl substances (PFAS) from water by adsorption: Role of PFAS chain length, effect of organic matter and challenges in adsorbent regeneration. Water Res 171, 115381, doi:10.1016/j.watres.2019.115381 (2020).
9 Espana, V. A. A., Mallavarapu, M. & Naidu, R. Treatment technologies for aqueous perfluorooctanesulfonate (PFOS) and perfluorooctanoate (PFOA): A critical review with an emphasis on field testing. Environmental Technology & Innovation 4, 168-181 (2015).
10 Carter, K. E. & Farrell, J. Oxidative destruction of perfluorooctane sulfonate using boron-doped diamond film electrodes. Environmental science & technology 42, 6111-6115 (2008).
11 Cheng, J., Vecitis, C. D., Park, H., Mader, B. T. & Hoffmann, M. R. Sonochemical degradation of perfluorooctane sulfonate (PFOS) and perfluorooctanoate (PFOA) in landfill groundwater: environmental matrix effects. Environmental science & technology 42, 8057-8063 (2008).
12 Vecitis, C. D., Park, H., Cheng, J., Mader, B. T. & Hoffmann, M. R. Treatment technologies for aqueous perfluorooctanesulfonate (PFOS) and perfluorooctanoate (PFOA). Frontiers of Environmental Science and Engineering in China 3, 129-151 (2009).
13 Stratton, G. R. et al. Plasma-based water treatment: efficient transformation of perfluoroalkyl substances in prepared solutions and contaminated groundwater. Environmental science & technology 51, 1643-1648 (2017).
14 Singh, R. K. et al. Breakdown Products from Perfluorinated Alkyl Substances (PFAS) Degradation in a Plasma-Based Water Treatment Process. Environmental Science & Technology 53, 2731-2738, doi:10.1021/acs.est.8b07031 (2019).
15 Wu, B. et al. Rapid Destruction and Defluorination of Perfluorooctanesulfonate by Alkaline Hydrothermal Reaction. Environmental science & technology letters, doi:10.1021/acs.estlett.9b00506 (2019).
16 Duchesne, A. L. et al. Remediation of PFAS-Contaminated Soil and Granular Activated Carbon by Smoldering Combustion. Environ Sci Technol 54, 12631-12640, doi:10.1021/acs.est.0c03058 (2020).
17 Robey, N. M., da Silva, B. F., Annable, M. D., Townsend, T. G. & Bowden, J. A. Concentrating Per- and Polyfluoroalkyl Substances (PFAS) in Municipal Solid Waste Landfill Leachate Using Foam Separation. Environ Sci Technol 54, 12550-12559, doi:10.1021/acs.est.0c01266 (2020).
18 Dixit, F. et al. Removal of Zwitterionic PFAS by MXenes: Comparisons with Anionic, Nonionic, and PFAS-Specific Resins. Environ Sci Technol 56, 6212-6222, doi:10.1021/acs.est.1c03780 (2022).
19 Ng, C. et al. Addressing Urgent Questions for PFAS in the 21st Century. Environ Sci Technol 55, 12755-12765, doi:10.1021/acs.est.1c03386 (2021).
20 Cui, J., Gao, P. & Deng, Y. Destruction of Per- and Polyfluoroalkyl Substances (PFAS) with Advanced Reduction Processes (ARPs): A Critical Review. Environ Sci Technol 54, 3752-3766, doi:10.1021/acs.est.9b05565 (2020).
21 Pinkard, B. R., Shetty, S., Stritzinger, D., Bellona, C. & Novosselov, I. V. Destruction of perfluorooctanesulfonate (PFOS) in a batch supercritical water oxidation reactor. Chemosphere 279, 130834, doi:https://doi.org/10.1016/j.chemosphere.2021.130834 (2021). 22 Yu, J., Nickerson, A., Li, Y., Fang, Y. & Strathmann, T. J. Fate of Per- and Polyfluoroalkyl
Substances (PFAS) during Hydrothermal Liquefaction of Municipal Wastewater Treatment Sludge. Environmental Science: Water Research & Technology, doi:10.1039/C9EW01139K (2020).
23 Gu, Y., Liu, T., Wang, H., Han, H. & Dong, W. Hydrated electron based decomposition of perfluorooctane sulfonate (PFOS) in the VUV/sulfite system. Sci Total Environ 607-608, 541-548, doi:10.1016/j.scitotenv.2017.06.197 (2017).
24 Bao, Y., Huang, J., Cagnetta, G. & Yu, G. Removal of F-53B as PFOS alternative in chrome plating wastewater by UV/Sulfite reduction. Water Res 163, 114907, doi:10.1016/j.watres.2019.114907 (2019).
25 Rao, U. et al. Structural Dependence of Reductive Defluorination of Linear PFAS Compounds in a UV/Electrochemical System. Environ Sci Technol 54, 10668-10677, doi:10.1021/acs.est.0c O₂₇₇₃ (2020).
26 Kugler, A. et al. Reductive defluorination of Perfluorooctanesulfonic acid (PFOS) by hydrated electrons generated upon UV irradiation of 3-Indole-acetic-acid in 12-Aminolauric-Modified montmorillonite. Water Res 200, 117221, doi:10.1016/j.watres.2021.117221 (2021).
27 Su, Y. et al. Potential-Driven Electron Transfer Lowers the Dissociation Energy of the C—F Bond and Facilitates Reductive Defluorination of Perfluorooctane Sulfonate (PFOS). ACS Appl Mater Interfaces 11, 33913-33922, doi:10.1021/acsami.9b10449 (2019).
28 Biswas, S., Yamijala, S. & Wong, B. M. Degradation of Per- and Polyfluoroalkyl Substances with Hydrated Electrons: A New Mechanism from First-Principles Calculations. Environ Sci Technol 56, 8167-8175, doi:10.1021/acs.est.2c01469 (2022).
29 Bentel, M. J. et al. Defluorination of Per- and Polyfluoroalkyl Substances (PFASs) with Hydrated Electrons: Structural Dependence and Implications to PFAS Remediation and Management. Environ Sci Technol 53, 3718-3728, doi:10.1021/acs.est.8b06648 (2019).
30 US EPA. Interim Guidance on the Destruction and Disposal of Perfluoroalkyl and Polyfluoroalkyl Substances and Materials Containing Perfluoroalkyl and Polyfluoroalkyl Substances (2020).
31 Phenix, B. D. Hydrothermal Oxidation of Simple Organic Compounds DOCTOR OF PHILOSOPHY thesis, Massachusetts Institute of Technology, (1998).
32 Wei, N. et al. Chemical reactions of organic compounds in supercritical water gasification and oxidation. Water Research 190, 116634, doi:https://doi.org/10.1016/j.watres.2020.116634 (2021).
33 Phenix, B. D. Hydrothermal Oxidation of Simple Organic Compounds PhD thesis, Massachusetts Institute of Technology, (1998).
34 Rosansky, S. Applying Supercritcial Water Oxidation to Destroy PFAS. The Military Engineer 113 (2021).
35 Li, J., Austin, C., Moore, S., Pinkard, B. R. & Novosselov, I. V. PFOS destruction in a continuous supercritical water oxidation reactor. Chemical Engineering Journal 451, doi:10.1016/j.cej.2022.139063 (2023).
36 Vadillo, V., Garcia-Jarana, M. B., Sinchez-Oneto, J., Portela, J. R. & de la Ossa, E. J. M. Supercritical water oxidation of flammable industrial wastewaters: economic perspectives of an industrial plant. Journal of Chemical Technology & Biotechnology 86, 1049-1057 (2011).
37 Krause, M., J. et al. Supercritical Water Oxidation as an Innovative Technology for PFAS Destruction. Journal of Environmental Engineering 148, 05021006, doi:10.1061/(ASCE)EE.1943-7870.0001957 (2022).
38 Marrone, P. A. Supercritical water oxidation-Current status of full-scale commercial activity for waste destruction. The Journal of Supercritical Fluids 79, 283-288, doi:10.1016/j.supflu.2012.12.020 (2013).

### SUMMARY OF THE INVENTION

The operating conditions of a SCWO continuous method and reactor (hereafter referred to as PFAS Annihilator™) have been developed and found to have several benefits for environmental remediation and waste management industries. The PFAS Annihilator™ consistently achieves near-complete destruction of PFAS, bringing the concentrations down to non-detect for most target PFAS, and consistently down to less than 70 ppt (parts per trillion) for all PFAS in under 30 seconds. This technology can be used to treat material contaminated with PFAS and other substances such as petroleum hydrocarbons or chlorinated solvents, which are also readily oxidized. Moreover, SCWO can be applied to a variety of PFAS-impacted liquids such as AFFF, landfill leachate, and investigation derived waste (IDW) due to its non-targeted carbon-fluorine bond destruction. The treated effluent is largely comprised of the products of complete combustion including carbon dioxide and water, and the corresponding anion acids; hence, the treated liquid can be released back into the environment after neutralization.

We have surprisingly found that destroying perfluorosulfonic acids (PFSAs) require conditions that are very different from the conditions needed to destroy other PFAS compounds.

In one aspect, the invention provides a method of destroying perfluorosulfonic acids (PFSAs) in an aqueous composition, comprising: passing an aqueous composition comprising perfluorosulfonic acids (PFSAs) in a reaction vessel in the presence of an oxidant at a temperature of at least 550° C. or at least 575° C. or at least 600° C., and a pressure of at least 3350 pounds per square inch (psi) or at least 3500 psi. Preferably, the method is conducted at a residence time of at least 8 seconds or at least 10 seconds or a residence time of 8 to 50 seconds or 8 to 10 seconds. As is conventional, residence time is the time the aqueous composition is contained within the reactor at the temperature and pressure.

The invention, in any of its aspects, may be further characterized by one or any combination of the properties described herein; or within +10%, or 20%, +30% of the properties described herein. The invention also includes methods of destroying PFAS or PFSAs or any of its constituents or combinations of constituents according to the temperature and/or pressure and/or residence times or within +10%, or ±20%, +30% of the temperature and/or pressure and/or residence times described herein including the Examples. The invention also includes methods of destroying PFAS or PFSAs wherein the feed to the reactor comprises one or any combination of the components in the Tables or within ±10%, or ±20%, +30% of the concentrations and within ±10%, or ±20%, +30% of the destruction percentages shown (up to 50 ppt or less).

### BRIEF DESCRIPTION OF THE DRAWINGS

FIG. 1A plots the results of continuous testing at 3350 to 3500 psi (228 to 238 atm) and a residence time of 8 to 10 seconds,

FIG. 1B shows the PFAS Annihilator™ process flow diagram showing flow paths, sample heating, reactor location, and sample cooling prior to collection of the effluent samples at the sampling port.

FIG. 2. PFAS destruction with H₂O₂ as the oxidant is equivalent or superior to the PFAS destruction when using dissolved oxygen as the oxidant. System operating at 600° C., 3500 psi, and 50 mL/min.

FIG. 3. Effect of temperature and residence time on PFAS destruction. At 575° C., the lowest flow rate (60 mL/min) resulted in the highest reduction and 100 mL/min the second highest reduction. At 600° C., the highest flow rate (190 mL/min) showed the least reduction.

FIG. 4. Natural logarithmic ratio in the effluent PFAS concentrations at four residence times.

FIG. 5A. ¹⁹F NMR spectra of PFOA and PFOS spiked influent and effluent samples. The x-axis is parts per million (ppm) and y-axis is relative intensity.

FIG. 5B. Concentration of PFAS and fluoride ions in the effluent overlaid with the reactor effluent temperature.

FIG. 6. Measured PFCAs, PFSAs, PFAS precursors/intermediates, and co-contaminants in treatments (a) Lab Sample, (B) Lab sample with co-contaminants spiked at low level, (C) Lab sample with co-contaminants spiked at high level, and (D) Field sample. The concentration of all PFAS compounds in the stream were less than 75 ppt after passing through the SCWO reactor.

FIGS. 7A-7B (Table 2) List of volatile organic compounds (VOCs) and total organic carbon analyzed.

FIGS. 8A-8E (Table 3) Concentration (ng/L) of PFAS entering and exiting the PFAS Annihilator™ SCWO reactor at different reactor operating temperatures and flowrates.

FIG. 9 (Table 4) PFAS Annihilator™ inlet and effluent concentrations (in ng/L) of PFAS at different time points during the two hours of steady state operation.

FIGS. 10A-10D (Table 5) PFAS and other co-contaminant concentrations (ppt) measured in separate tests performed on PFAS Annihilator™: (A) PFAS Spiked Lab sample; (B) PFAS Spiked Lab sample with the addition of low level TPH and VOC spikes; (C) PFAS Spiked Lab sample with the addition of high level TPH and VOC spikes; and (D) Field-collected sample.

### DETAILED DESCRIPTION OF THE INVENTION

Operating conditions that destroy most perfluoroalkyl carboxylic acids (PFCAs) are lower than required for their sulfonated counterparts (PFSAs). The requirements for PFCAs are: temperature ≥450° C.; pressure ≥3350 PSI; residence time about 5 seconds although a shorter residence time and/or lower temperatures might also work for PFCAs.

In order to destroy perfluorosulfonic acids (PFSAs), additional heat and/or a longer residence time is required. A temperature of 550° C. or greater is needed to destroy appreciable amounts of the PFSAs; a temperature of at least 575° C. or greater is needed to destroy most of the PFSAs at the longer residence times; and a temperature of at least 600° C. or greater is needed to destroy most of the PFSAs at most of the tested residence times of 8 to 10 seconds. It is believed that within these temperature requirements, longer residence times will achieve destruction at the lower temperature range.

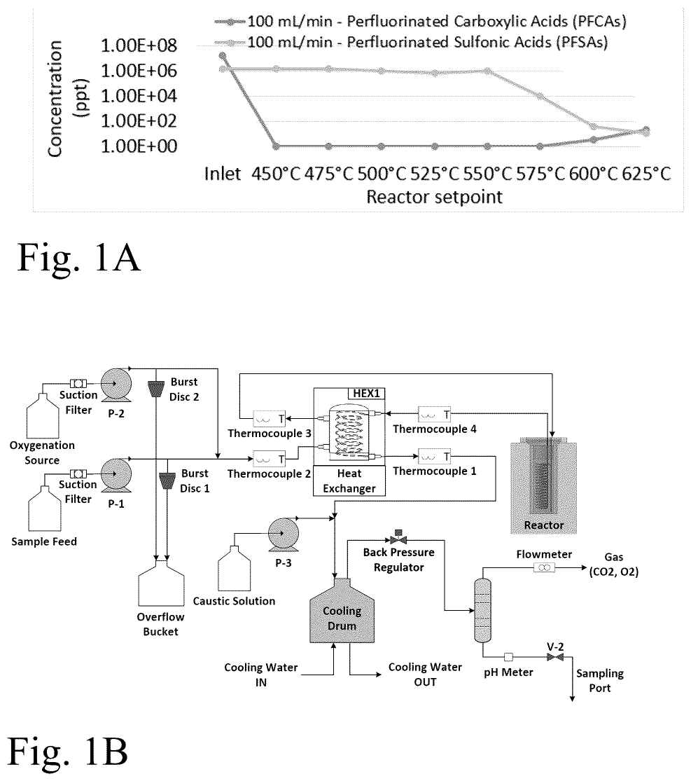

As shown in FIG. 1A, in continuous testing at 3350 to 3500 psi (228 to 238 atm) and a residence time of 8 to 10 seconds, it appears that temperatures above 450° C. to about 550° C. do not result in additional destruction of PFSAs. Surprisingly, however, we discovered that at temperatures above 550° C. or at least 575° C. or at least 600° C. was necessary for a substantial destruction of PFSA.

A preferred SCWO reactor design is a continuous or semi-continuous system in which the (typically pre-treated) PFAS-containing aqueous solution is passed into a SCWO reactor. Because solids may form in the SCWO reactor, it is desirable for the reactor to slope downward so that solids are pulled by gravity downward and out of the reactor. In some embodiments, the flow path is straight and vertical (0°) with respect to gravity; in some embodiments, the reactor is sloped with respect to gravity, for example in the range of 5 to 70° (from vertical) or 10 to 50° or 10 to 30° or 10 to 20° and can have a bend so that flow moves in a reverse direction to provide a compact device in which flow is consistently downward with respect to gravity. Preferably, the reactor vessel is a cylindrical pipe formed of a corrosion resistant material. Desirably, the pipe has an internal diameter of at least 1 cm, preferably at least 2 cm and in some embodiments up to about 5 cm.

Flow through the components of the SCWO apparatus at supercritical conditions should be conducted under turbulent flow (Re of at least 2000, preferably in the range of 2500 to 6000). Effluent from the SCWO reactor can flow into a salt separator under supercritical conditions.

### Oxidants

The two tested feedstocks of reactant oxygen used in supercritical water oxidation for destruction of PFAS are oxygen gas (O₂) and hydrogen peroxide (H₂O₂). In addition to, or alternative to, these two chemical species, other reactant oxygen sources or oxidizing agents could be added to destroy PFAS in the oxidation reactor. Other oxidants may comprise oxyanion species, ozone, air, and peroxy acids.

The preferred oxidant has a high oxygen density, such as hydrogen peroxide, which can be added in excess (for example an excess of at least 50% or at least 100% or in the range of 50% to 300% excess) and the excess hydrogen peroxide reacting to form dioxygen and water.

### Additional Conditions

Any of the inventive processes can be characterized by one or any combination of the following: a PFAS-containing solution is mixed with a solution comprising 30 to 50 wt % H₂O₂ at a PFAS-containing solution:H₂O₂ solution weight ratio of preferably 30:1 to 70:1 wt % ratio or in a particularly preferred embodiment approximately 50:1 PFAS solution:H₂O₂. Desirably, sufficient or excess is present to oxidize all the components in the aqueous composition. In some embodiments, the PFAS-containing solution is passed through a SCWO reactor with a residence time of 60 sec or less, preferably 20 sec or less, 10 sec, or 5 sec or less, or 0.5 to 5 seconds. In reactors in which the PFAS is destroyed in supercritical conditions, the reactor volume is based on the volume comprising supercritical fluid conditions. A preferred reactor configuration is a continuous plug flow reactor. In some embodiments, the feed of concentrated PFAS is passed into an oxidation reactor a rate of about 50 mL/min; in some embodiments rate is controlled between 50 and 150 mL/min (at STP); this rate can be adjusted to obtain the desired conditions. The feed can include fuel and oxidant. Preferably, no external heating is required after start-up. In some embodiments, the PFAS-containing aqueous mixture (preferably after a concentration pretreatment) comprises at least 100 ppm of perfluorinated sulfonates and the method decreases the perfluorinated sulfonates concentration by at least 10³ or 10⁶ or 10⁸, and in some embodiments up to about 10⁹. Any of these conditions may be utilized or obtained in a mobile unit.

### Examples

### Chemicals and Reagents

Laboratory-prepared feeds were spiked with technical grade PFOA (98% purity), and PFOS (98% purity), along with lower amounts of PFBA, PFPeA, PFHxA, PFHpA, PFDA, PFUnDA, PFDoDA, 8:2 FTS, N-MeFOSAA, N-EtFOSAA, L-PFBS, and PFBS (Synquest Laboratories [Alachua, FL], Sigma Aldrich [St. Louis, MO] and Wellington Laboratories [Ontario, Canada]) (Table 1). Volatile organic compounds (VOCs; 1,1-dichloroethene, benzene, tetrachloroethene, toluene, and trichloroethene) (SPEX CertiPrep, Metuchen, NJ) and diesel fuel (Turkey Hill, OH) were added as co-contaminants. Final concentrations in the inlet feed were determined through PFAS, total organic carbon (TOC), and VOC analysis. The full list of PFAS and organic compounds evaluated are shown in Tables 1 and Table 2, respectively, but only detected compounds are presented in the figures for visual clarity. Optima™ grade methanol (≥99.9% purity) (Sigma Aldrich), and certified American Chemical Society grade acetone (≥99.5% assay) and ammonia (7 N solution in methanol) (Fisher Scientific [Pittsburgh, PA]) were used to clean the reactor between trials. Hydrogen peroxide (H₂O₂) from Sigma Aldrich was used as the oxygen source, and monobasic sodium hydroxide (NaOH) from Sigma Aldrich was added to the process to neutralize the effluent stream. Deionized (DI) water was produced in house via a two-tank deionizing system in parallel, installed and maintained by AmeriWater (Dayton, OH).

TABLE 1
Definition of PFAS grouping and acronyms and the detection limit
in water.

| | | | |
|---|---|---|---|
| | | | Detection |
| | | | Limit |
| Abbreviation | Analytes | CAS RN | (ng/L) |

Perfluorinated Carboxylic Acids (PFCAs)

| | | | |
|---|---|---|---|
| PFBA | Perfluorobutanoic acid | 375-22-4 | 0.14 |
| PFPeA | Perfluoropentanoic acid | 2706-90-3 | 0.31 |
| PFHXA | Perfluorohexanoic acid | 307-24-4 | 0.19 |
| PFHpA | Perfluoroheptanoic acid | 375-85-9 | 0.16 |
| PFOA | Perfluorooctanoic acid | 335-67-1 | 0.18 |
| PFNA | Perfluorononanoic acid | 375-95-1 | 0.26 |
| PFDA | Perfluorodecanoic acid | 335-76-2 | 0.16 |
| PFUnA | Perfluoroundecanoic acid | | |
| PFDOA | Perfluorododecanoic acid | 307-55-1 | 0.18 |
| PFTrDA | Perfluorotridecanoic acid | 72629-94-8 | 0.15 |
| PFTeDA | Perfluorotetradecanoic acid | 376-06-7 | 0.25 |

Perfluorinated Sulfonic Acids (PFSAs)

| | | | |
|---|---|---|---|
| PFBS | Perfluorobutanesulfonic acid | 375-73-5 | 0.13 |
| PFPeS | Perfluoropentanesulfonic acid | 2706-91-4 | 0.67 |
| PFHxS | Perfluorohexanesulfonic acid | 355-46-4 | 0.11 |
| PFHpS | Perfluoroheptanesulfonic acid | 375-92-8 | 0.2 |
| PFOS | Perfluorooctanesulfonic acid | 1763-23-1 | 0.19 |
| PFNS | Perfluorononanesulfonic acid | 68259-12-1 | 0.46 |
| PFDS | Perfluorodecanesulfonic acid | 335-77-3 | 0.17 |

Precursors/Intermediates

| | | | |
|---|---|---|---|
| PFOSA | Perfluorooctanesulfonamide | 754-91-6 | 0.27 |
| NMeFOSAA | N-Methylperfluorooctane | 2355-31-9 | 0.56 |
| | sulfonamido acetic acid | | |
| NEtFOSAA | N-Ethylperfluorooctane | 2991-50-6 | 0.49 |
| | sulfonamido acetic acid | | |
| 4:2FTS 4:2 | fluorotelomer sulfonic acid | 757124-72-4 | 0.14 |
| 6:2FTS 6:2 | fluorotelomer sulfonic acid | 27619-97-2 | 1.36 |
| 8:2FTS 8:2 | fluorotelomer sulfonic acid | 39108-34-4 | 0.22 |

Note:
CAS No. chemical abstract service registry number

### SCWO Reactor

The bench-scale PFAS Annihilator™ is comprised of a tubular reactor heated by an Accurate Thermal Systems (Hainesport, NJ) sand bath. A tube-in-tube heat exchanger was used to preheat the feed and recover heat after the reaction. Additional cooling of the reactor effluent was performed using a cooling drum supplied with potable water. A custom-designed gas-liquid separator was used to separate the treated aqueous effluent from the generated vapor. The feeds, oxidant, and neutralization solutions were pumped through the PFAS Annihilator™ utilizing Shimadzu (Columbia, MD) LC 20-AP preparative pumps. Pressure was monitored throughout the system with in-line Swagelok (Solon, OH) 6,000 psi pressure gauges. Pressure was maintained in the system utilizing a Tescom (Elk River, MN) 4,000 psi back pressure regulator. Effluent pH was measured using a Sensorex (Garden Grove, CA) TX100 in-line pH meter. Temperatures were measured with in-line Type K thermocouple probes (Omega, Norwalk, CT). A schematic of the PFAS Annihilator™ used to evaluate the destruction of PFAS is shown in FIG. 1B. The temperature readings were output to a BrainChild PR20 data logger (CAS Dataloggers, Chesterland, OH). Due to the high temperatures and pressure operating conditions and the generation of hydrofluoric acid, a high nickel alloy (Alloy 625) that is highly resistant to corrosion was used for all hot and pressurized components of the system. No glassware or other laboratory ware is used anywhere in the system or in the handling of samples destined for PFAS analysis to mitigate the potential for PFAS loss to glassware.

### Laboratory Samples

Laboratory-prepared inlet samples were composed of PFAS, petroleum hydrocarbons, and/or VOCs prepared in DI water, followed by sonication for at least 1 hour. Anions can be analyzed using U.S. EPA Method 300 and Modified EPA 300.0 and 300.1. TOC can be analyzed using U.S. EPA Method 9060A; VOCs analyzed by U.S. EPA Method 8260C; Target PFAS by LC-MS/MS QSM v 5.3 B-15; and non-target PFAS by LC/ToF/MS.

### Field Samples

Upon receipt, all field samples were analyzed for PFAS, VOCs, TOC, and anions as described above. The TOC and PFAS concentrations were used to calculate an appropriate oxidant dosing for the field sample. The field sample detailed in this report was run through the PFAS Annihilator™ without any preprocessing or preparation.

### SCWO Operating Conditions

At the beginning of each run, the SCWO reactor was allowed to reach its equilibrium temperature (±10° C.) running DI water at 3,500 psi (±200 psi). The oxidant solution was prepared to achieve ≥100% excess oxygen in the system, calculated assuming complete combustion of the TOC and/or total target PFAS in the feed. Either the liquid oxidant (H₂O₂) or the dissolved gaseous oxygen was pumped via a secondary Shimadzu LC-20AP preparative pump into the system upstream of the reactor at 3,500 psi along with the feed/sample stream. A neutralization solution (NaOH) was prepared such that an effluent pH of 5 to 7 was achieved while ensuring the neutralization flow did not exceed 7% of the total system flowrate. The feed and oxidant were introduced into the PFAS Annihilator™ at their specified flowrates after the system temperature stabilized. The vapor stream, primarily consisting of carbon dioxide and excess oxygen, was separated from the aqueous stream in a gas-liquid separator and sampled by C18 cartridges and impingers prior to being discharged into the laboratory hood. The liquid effluent samples were collected from the sampling port as labeled in FIG. 1B.

After each run was completed, the system was immediately flushed with DI water and/or low concentration oxidant. After cooling, the system was rinsed with DI water, methanol, and then again with DI water. For runs with a high concentration of PFAS or where operating conditions were not optimal for PFAS destruction, ammonia in methanol and/or acetone was also used to clean the system.

### Sample Analysis

All samples were analyzed for PFAS at Battelle's accredited laboratory, using isotope dilution liquid chromatography tandem mass spectrometry (LC/MS/MS). Transformation byproducts formed during SCWO were analyzed using Waters Acuity I-class UPLC Sample Manager coupled to a Quadrupole time-of-flight mass spectrometer, TripleTOF/MS 5600 (AB Sciex, Framingham, MA) at Battelle's Laboratory. The aqueous influent, effluent, and equipment blanks, and gaseous effluents (methanol extracts of C18 cartridges and impinger) were investigated for transformation byproducts. Details on all analytical methods for PFAS are described in the Supporting Information. To characterize fluorine changes, influent and effluent samples were analyzed using ¹⁹F-Nuclear Magnetic Resonance (NMR) spectroscopy at Battelle's Laboratory. The ¹⁹F NMR spectra were obtained with a Bruker AVANCE NEO 500 MHz NMR spectrometer equipped with a broadband observe probe with gradients in a mixture of water and deuterium oxide as the solvent. Chemical shifts were reported relative to CFCl₃ (0 part per million [ppm]). Fluoride was also commercially evaluated by anion analysis using U.S. EPA Method 300. TOC and VOCs were commercially analyzed using U.S. EPA Methods 9060A and 8260C, using samples collected in volatile organic analysis vials preserved with phosphoric acid and hydrochloric acid, respectively.

### Data Analysis

The relative change of PFAS, fluoride, TOC, and VOCs was determined by comparing the inlet and effluent concentrations of the system. Equations for percent destruction and defluorination can be found in Equation 1 and Equation 2. This analysis assumes that little, if any, accumulation of compounds occurred in the SCWO system for accurate representation of compound destruction/production. The reported effluent concentrations are those directly measured exiting the reactor without correcting for dilution from the addition of the oxidant or neutralization solutions. This provides an accurate representation of the reactor discharge. Since the feed sample is diluted by less than 15% when using H₂O₂ as the oxidant, the concentration changes reported are representative of the reactor performance and are not due to significant dilution of the feed stream.

$$\% destruction = \frac{effluent concentration of PFAS ( \frac{ng}{L} )}{inlet PFAS concentration as organofluorine ( \frac{ng}{L} )} \times 100 \qquad Equation 1$$

$$\% defluorination = \frac{effluent inorganic fluoride ( \frac{ng}{L} )}{inlet PFAS concentraiton as organofluorine ( \frac{ng}{L} )} \times 100 \qquad Equation 2$$

To simplify the data presentation when the concentration of many PFAS are being reported, the PFAS are classified as PFCAs, PFSAs, and precursors/intermediates as defined in Table 1, and the raw concentration values of each measured PFAS compound are then tabulated.

### Results and Discussion

Using the laboratory-spiked inlet samples, the effects of oxidant type, temperature, and residence time on the SCWO destruction of PFAS were evaluated.

### Impact of Oxidant Type on PFAS Destruction

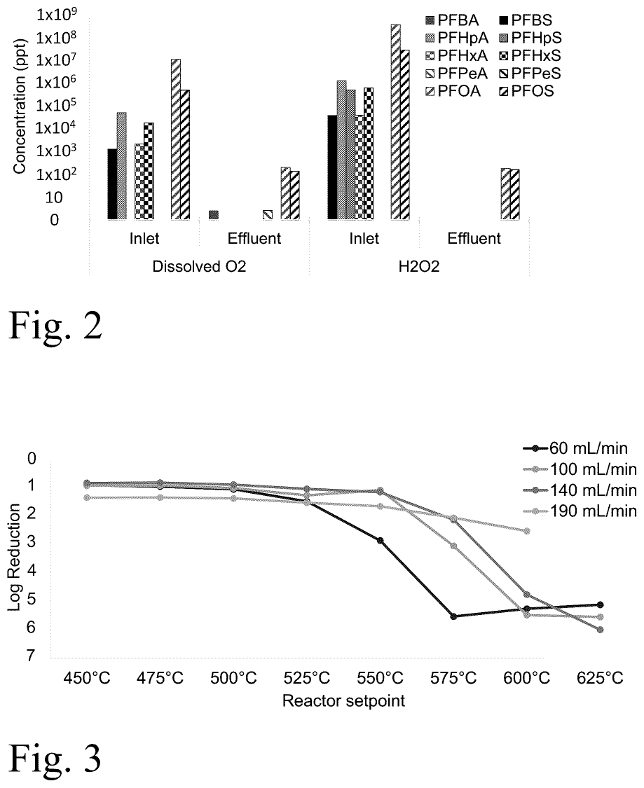

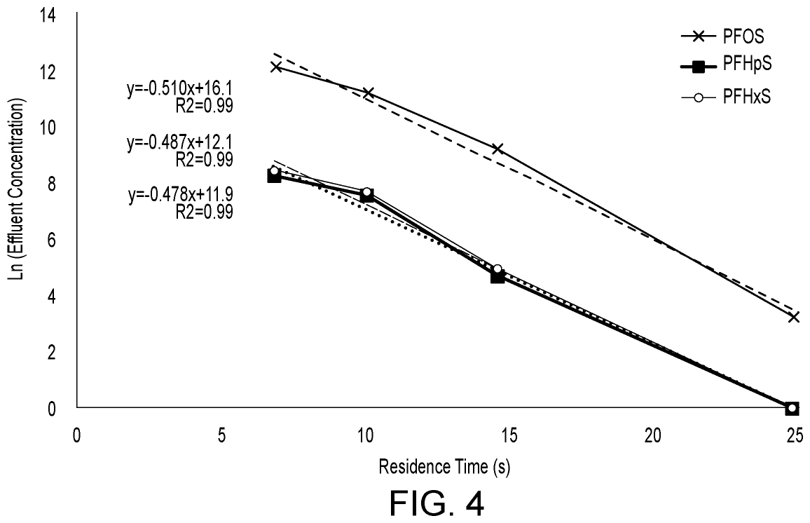

Two oxidant sources, dissolved oxygen in water and H₂O₂, were used to provide at least 100% excess oxygen in independent tests. In the initial investigation, H₂O₂ provided equivalent or superior destruction of all measured PFAS, including PFCAs (PFBA, PFPeA, PFHxA, PFHpA, and PFOA) and PFSAs (PFBS, PFPeS, PFHxS, PFHpS, and PFOS) compared to dissolved oxygen as the oxidant source when operating at 3,500 psi and 600° C. (FIG. 2). Both oxidants caused a similar 4 to 6 log reduction in the concentration of the total effluent PFAS relative to the total inlet concentration of 11.3 ppm. In both cases, only the two compounds having the highest concentrations in the inlet (PFOA and PFOS) were still present at over 100 ppt in the effluent; The other measured compounds were not detected or were detected at less than 3 ppt. H₂O₂ has about 1,000× higher oxygen density than oxygen dissolved in water at 100 psi, dramatically reducing the required volume of oxidant added to the feed stream and reducing the combined reactor volumetric flowrate by ˜5×. This greatly reduces the volume of water that must be heated when operating the reactor, reducing energy requirements and cost of operation. Other researchers have also observed accelerated oxidation performance with H₂O₂ compared to oxygen on organic contaminants. Ren, M. et al. Supercritical water oxidation of quinoline with moderate preheat temperature and initial concentration. Fuel 236, 1408-1414 (2019). This is due to the high activation energy of O₂ oxidation and the slow conversion of O₂ and H₂O that requires three steps to produce OH radicals as shown in Equation 3 through Equation 5. Alternatively, the decomposition of H₂O₂ to OH radicals is direct (Equation 5). Due to the equivalent or improved destruction of PFAS when using H₂O₂ in this study and in the literature, H₂O₂ is used as the oxidant source for the remaining tests.

CF₃(CF₂)ₙRH+O₂→CF₃(CF₂)ₙR·+HO₂· Equation 3

CF₃(CF₂)ₙRH+HO₂·→CF₃(CF₂)ₙR·+H₂O₂ Equation 4

H₂O₂→20H· Equation 5

### Impact of Residence Time and Temperature on Performance

The combination of elevated temperature and residence time provides enough energy to overcome the activation energy to cleave the carbon-fluorine bond to degrade PFAS to produce carbon dioxide (CO₂) and hydrofluoric acid (1F). A generic reaction is shown in Equation 6 using PFOA as an exemplar PFAS.

C₈HF₁₅O₂+7H₂O₂→15HF+8CO₂ Equation 6

To determine the optimal operating conditions, influent and effluent concentrations of PFAS were measured at four flowrates in 25° C. increments from 450° C. to 625° C. At least 85% of total PFAS were destroyed under all tested conditions. Between the operating temperatures of 450° and 525° C., the reactor operated in this ≥85% destruction efficiency regardless of flowrate. A similar observation was made by other researchers studying the batch-scale reactions of PFOS, where the highest PFAS destruction was observed at 500° C., and the reaction at this temperature was independent of the residence time; therefore, it was concluded that temperature is the key parameter for PFAS destruction (Pinkard, B. R., Shetty, S., Stritzinger, D., Bellona, C. & Novosselov, I. V. Destruction of perfluorooctanesulfonate (PFOS) in a batch supercritical water oxidation reactor. Chemosphere 279, 130834 (2021)). However, the current study expanded to higher temperatures using a flow through system. This setup shows that, further elevated temperatures allowed the reaction to destroy >99% of PFAS. Destruction of PFAS is inversely dependent on residence time or indirectly dependent on the reactor flowrate.

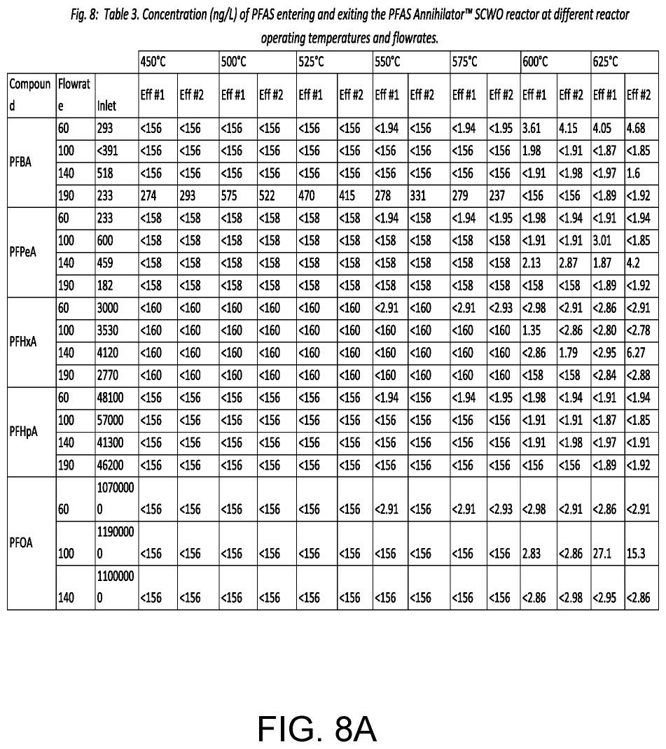

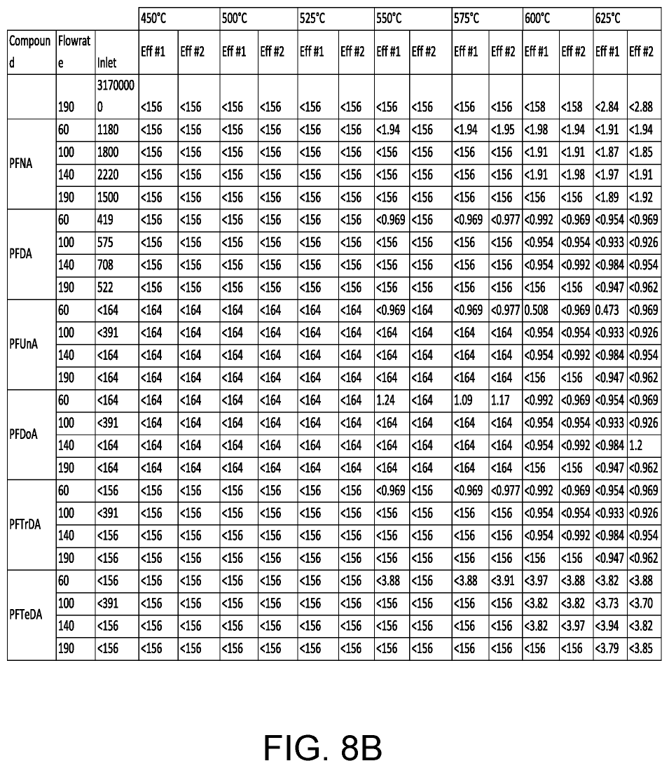

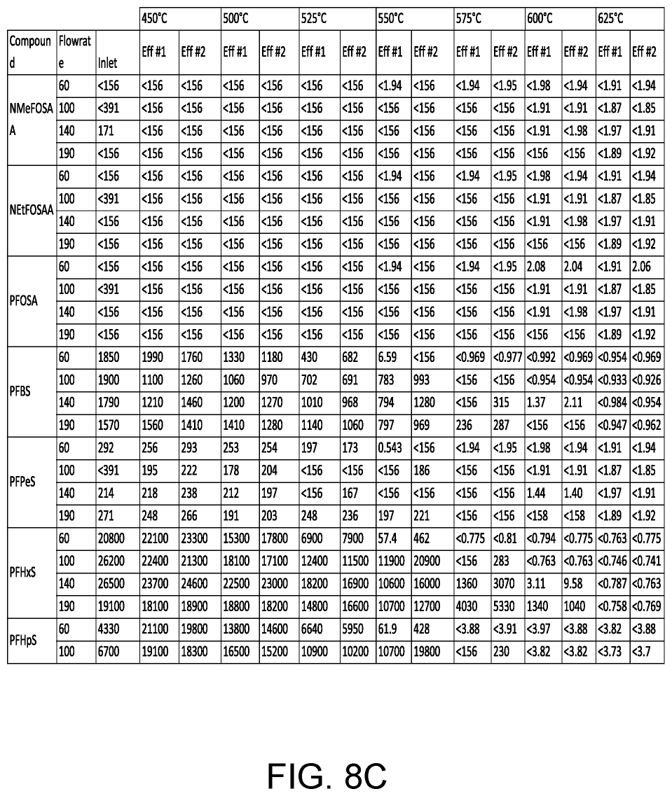

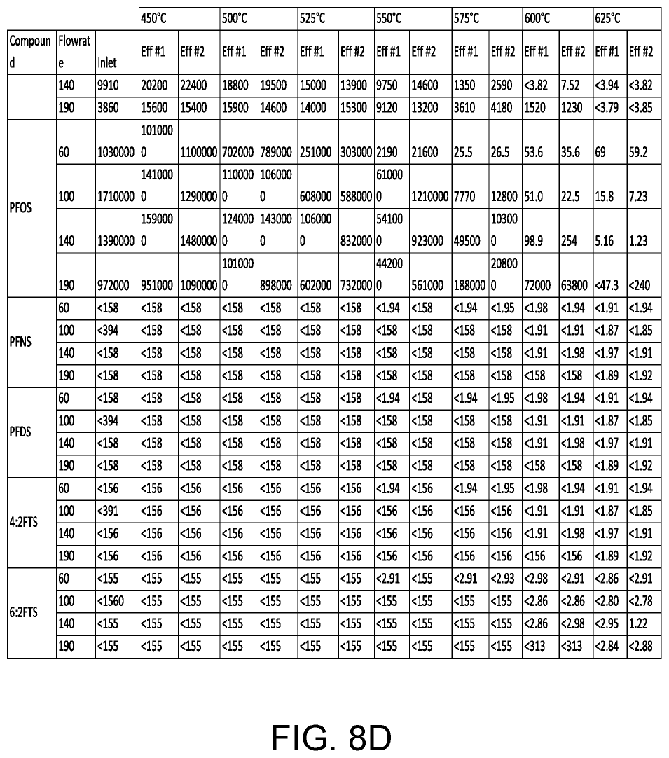

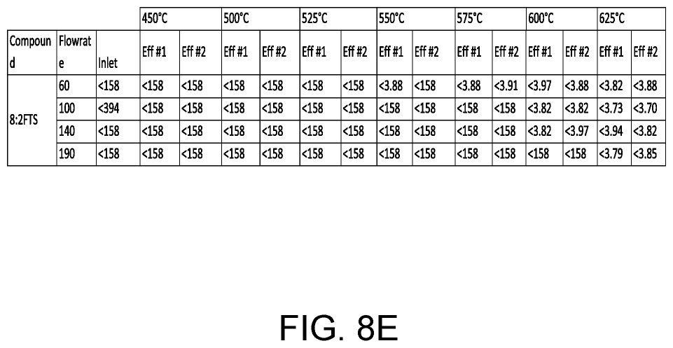

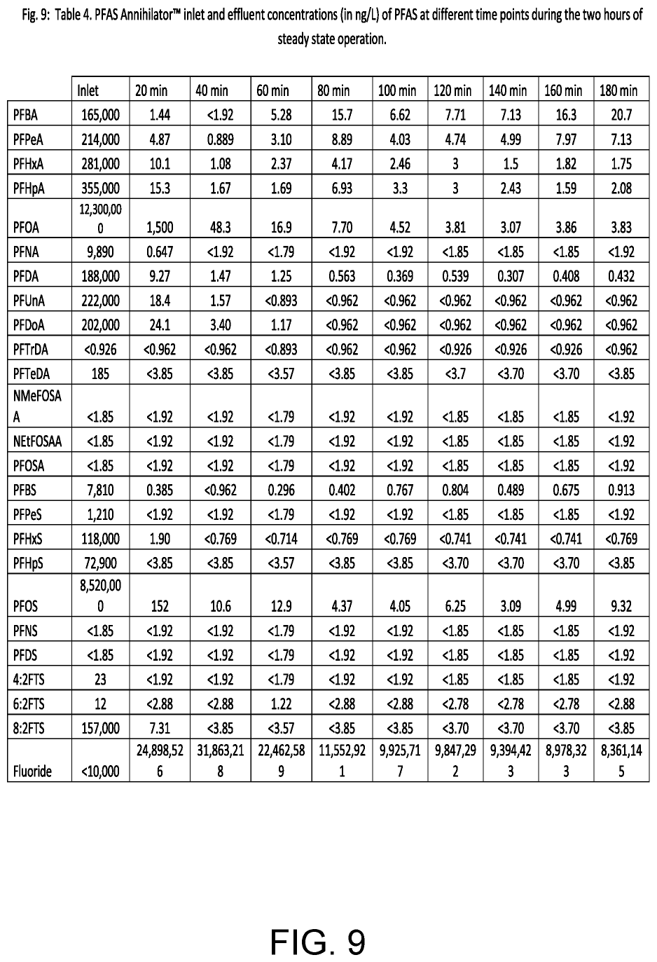

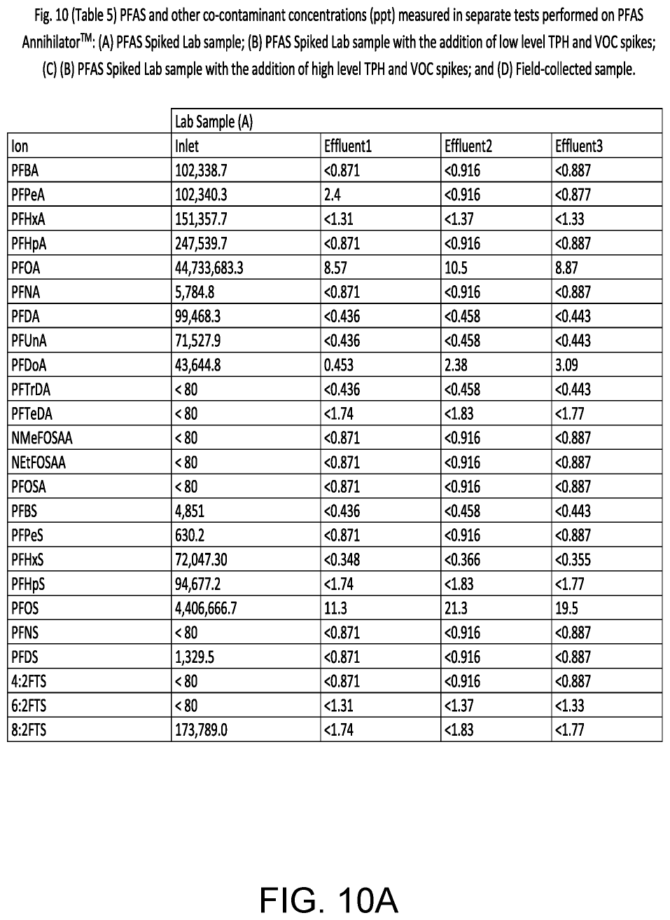

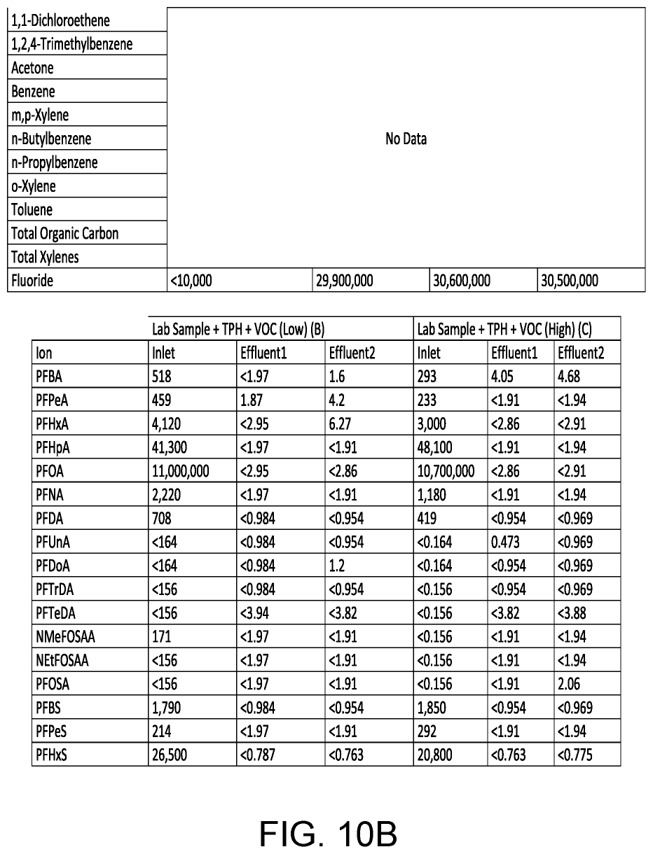

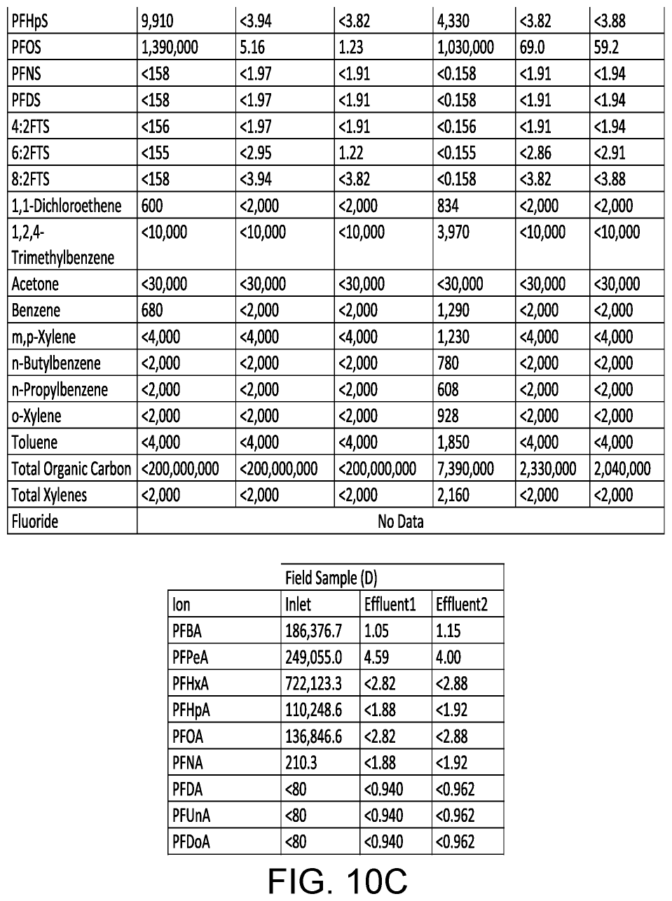

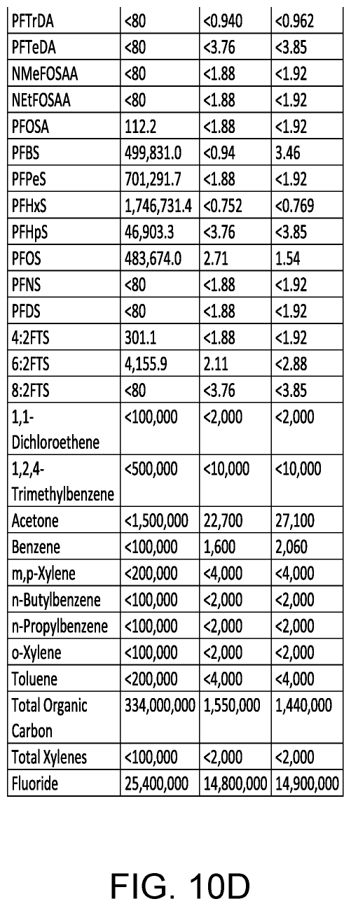

At temperatures ≥525° C., slower flowrates show improved PFAS destruction. A slower flowrate also achieves maximum destruction at lower temperatures compared to reactions run at higher flowrates. At 550° C. the slowest tested flowrate (60 mL/min) showed an additional 1- to 2-log reduction in the effluent PFAS concentration than seen at any of the other tested flowrates (100, 140, and 190 mL/min). At 575° C. the 60 mL/min flowrate achieves the maximum PFAS destruction (about 5-6 log reduction). Increasing flowrates at this operating temperature (575° C.) reduced PFAS destruction efficiency. Further increasing the temperature allowed higher flowrate streams to also achieve the maximum PFAS destruction. However, the reactor was unable to maintain a temperature of 625° C. at 190 mL/min due to the energy transfer required to heat the high influent flowrate. Figure summarizes these data. The concentration of all 24 PFAS from each of two sequential samples collected at each set of conditions is shown in Table 3 (FIG. 8). Interestingly, the non-sulfonated PFAS (PFCAs) showed complete defluorination at all temperatures and flowrates evaluated, while the sulfonated acids (PFSAs) required a higher temperature and residence time to be defluorinated. The degradation of the PFCAs makes up nearly all the destruction seen at temperatures ≤500° C.

### Estimated Reaction Kinetics

The reactor flowrates were converted to residence times to estimate the reaction kinetics for the degradation of PFAS within the reactor. The residence time at each data point shown in Figure is unique because under supercritical conditions, the reaction temperature has a notable impact on density, leading to variable residence times for a consistent volumetric flowrate. The reaction rates were estimated using the PFAS compounds whose concentrations were above the limit of quantitation (LOQ) for all four tested residence times, which only included PFSAs (all PFCAs were destroyed under all test conditions). A reactor operating temperature of 575° C. was used for these calculations because it shows the greatest disparity in the destruction efficiency of PFAS over the tested flowrate range. At lower or higher temperatures, the reaction is either not at all impacted by the residence time, or there is only one data point that is not at either the maximum (Cₜ/C₀≅1E-5) or minimum (Cₜ/C₀≅1E-1) destruction, meaning that there are not sufficient data points sampled to properly estimate the kinetics at those temperatures. Figure indicates first order reaction kinetics at 575° C. and provides rate constants (k) of 0.51, 0.49, and 0.48 for PFOS, PFHxS, and PFHpS, respectively.

The first-order reaction equation for PFSA destruction is shown in Equation 7. Although not

ln(A)=ln(A₀)−kt Equation 7

shown in Figure, shorter chain PFSAs and all PFCAs proceeded to non-detect (ND) quickly, which prevented an accurate rate calculation for those compounds (Table 4).

### Steady State Operation

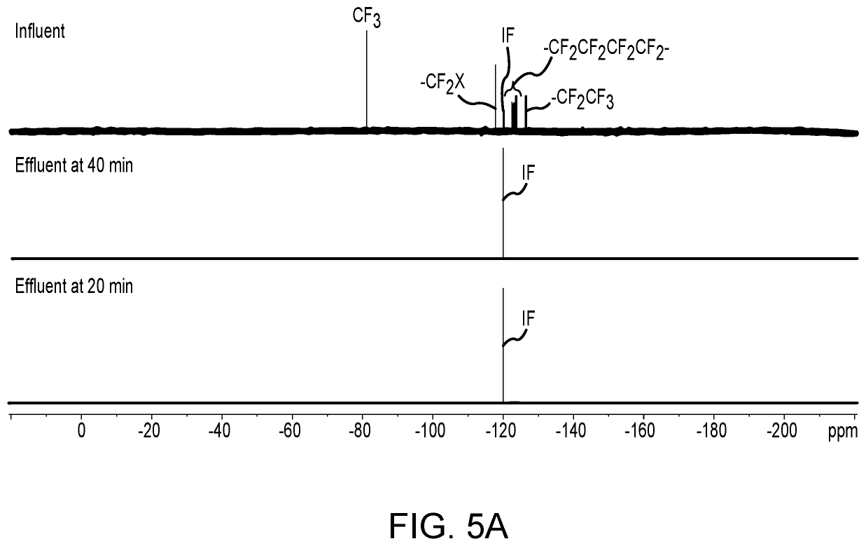

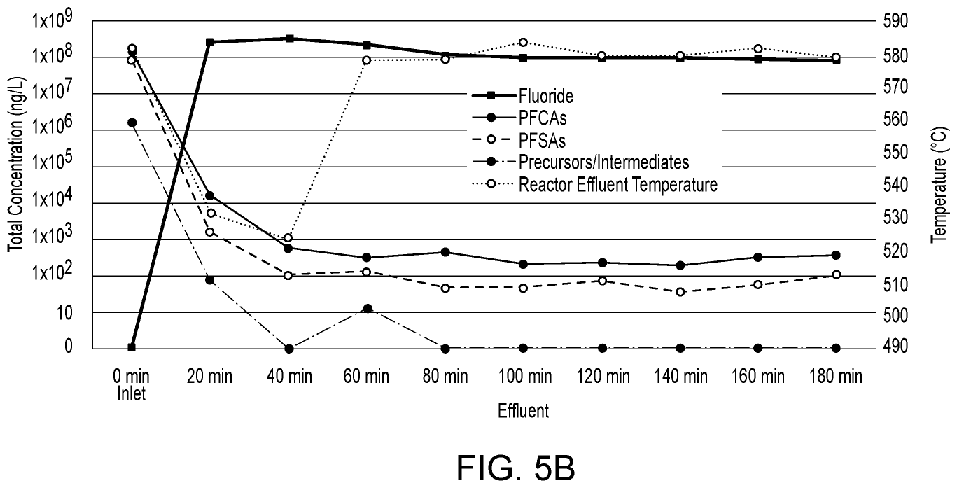

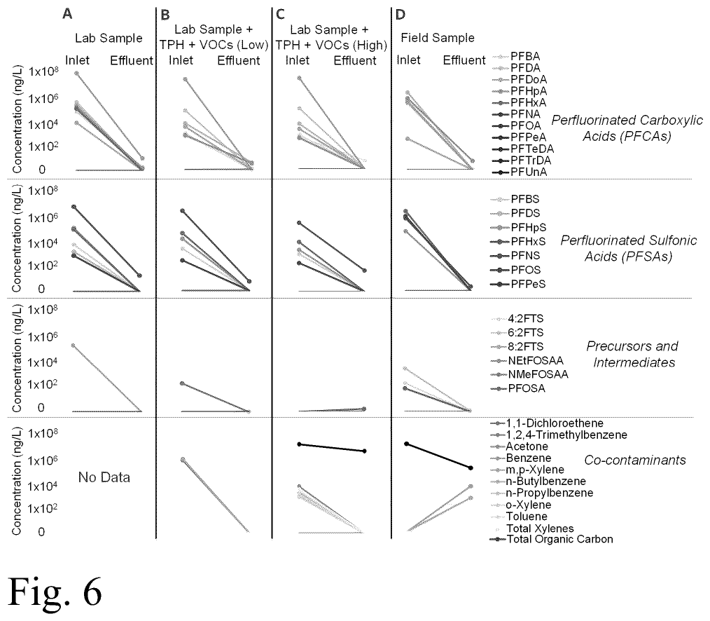

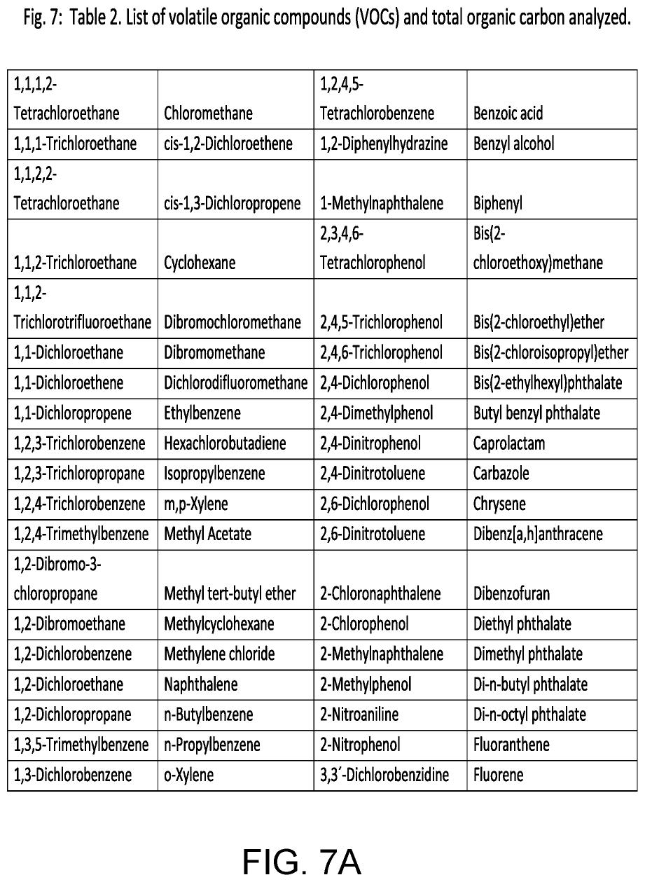

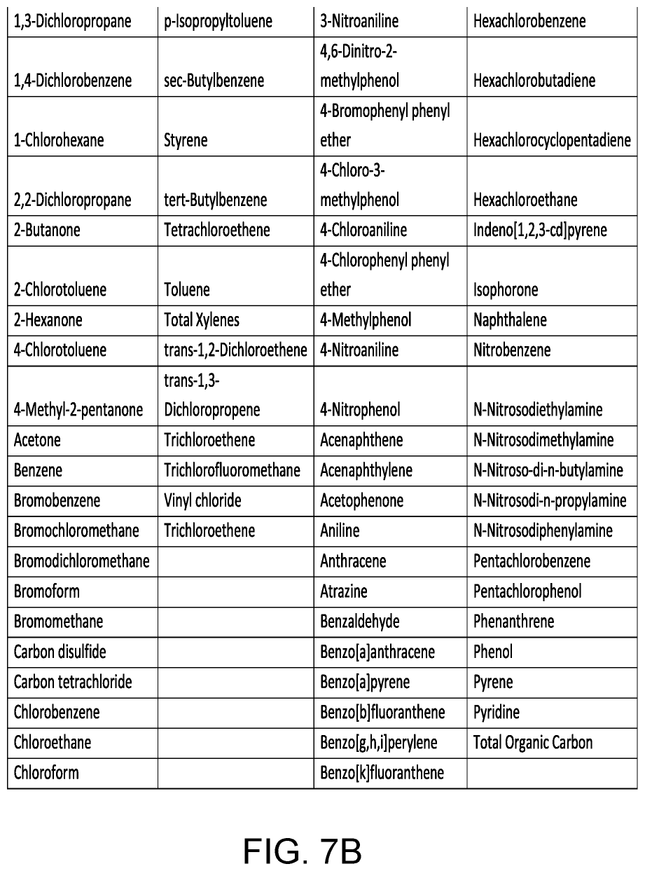

To determine the startup and steady-state operation of the PFAS Annihilator™, the system was operated for 3 hours with effluent samples collected every 20 minutes. These samples were analyzed to measure the loss of target PFAS and the generation of inorganic fluoride. The concentration of PFAS in the effluent decreased by ˜4 orders of magnitude within 20 minutes of introducing the feed solution, while the effluent fluoride concentration increased dramatically. The concentration of PFAS was reduced by another order of magnitude after another 20 minutes of operation, while the fluoride remained at nearly the same level (FIG. B). This is expected as there is a diminishing return in total generated fluoride as the concentration of PFAS undergoes further log reductions. The large increase in fluoride concentration in the effluent suggests mineralization of PFAS by defluorination during the SCWO treatment. In addition, ¹⁹F NMR analysis of influent and steady-state effluent samples further supports this finding. There is an increase in inorganic F peak in effluent spectra, and disappearance of organofluorines (F attached to carbons) resulting from defluorination of PFAS (FIG. 5A). Although ¹⁹F NMR spectra represents a qualitative analysis, disappearance of the organofluorine peaks further demonstrates the complete defluorination of PFAS.

The reactor showed a slight 15° C. decrease in the effluent temperature for the first 40 minutes of operation, which was recovered and even slightly elevated by 60 minutes of continuous operation. By 60 minutes of continuous operation, all measured parameters had reached a steady value and remained constant for the remaining 120 minutes of testing, suggesting about a 1-hour time to steady state for the PFAS Annihilator™ (FigureB). Additionally, the status of the reactor is well summarized by the temperature reading; When the reactor effluent temperature has re-equilibrated after the introduction of sample, the SCWO system is operating at steady state and is achieving optimal PFAS destruction.

Throughout this steady-state period, the total effluent PFAS concentration remained below 50 ppt, which is six orders of magnitude lower than the total inlet PFAS concentration of 22.8 ppm (99.9998% destruction). The most concentrated compound in the inlet (PFOA) was decreased by nearly 7 orders of magnitude from 12.3 ppm to 3.83 ppt. The inlet and effluent concentrations for fluoride and for all 24 measured PFAS are provided in Table 5.

Comparing the total inlet and effluent fluorine, a total of 72.6% of the total inlet fluorine (largely contained in the PFAS) is detected and quantified in the effluent as ionic fluoride. While this may indicate that some fluorine is accumulating within the reactor, the reactor was rinsed with water after testing to collect any fluorine sorbed onto the reactor surfaces. While some fluoride was detected (0.77 mg/L), this totaled less than 0.5% of the total inlet fluorine, suggesting that the reaction byproducts are not accumulating within the reactor. The total target PFAS measured in the post run water rinse was also low (27.0 ppt), further suggesting that undestroyed PFAS is not adhering to or building up on the reactor walls. This data suggests that neither PFAS nor the reaction product, fluorine, are accumulating within the reactor. In addition, the reactor surface residuals were collected and analyzed via energy dispersive spectroscopy (EDS) and x-ray diffraction (XRD) and show that there is no fluorine detected on these surfaces, further supporting the idea that PFAS are destroyed rather than accumulated or sorbed onto the reactor surfaces. Additional effort is underway to better understand the movement of fluorine through the reactor.

### Effect of Co-Contaminants on PFAS Annihilation

The PFAS Annihilator™ has been demonstrated to greatly reduce the concentration of PFAS in laboratory-spiked samples (Figure, Figure, FigureB); However, environmental samples are much more complex and can have a number of additional co-contaminants. In many of the Department of Defense (DoD) sites impacted by AFFFs due to fire-fighting or fire-training activities, it is common to find VOCs and total petroleum hydrocarbons (TPH) commingled with PFAS contamination. To evaluate the practicality of applying this technology to environmental remediation, a laboratory-spiked sample was prepared consisting of PFAS, TPH (low and high concentration), and VOCs (low and high concentrations). The low-concentration spiked sample was found to contain ˜1,200 ppt of total organic contaminants, and the high-concentration spiked sample was found to contain ˜7,400,000 ppt of total organic contaminants. The measurable TOC concentrations are shown in the bottom row of Figure, and detailed data of all analytes is provided in Table 5. The results show that the destruction of PFAS is largely unaffected by the addition of organic co-contaminants when compared to the laboratory sample that was only spiked with PFAS (FIG. A) and that the total concentration of co-contaminants also decreases (FigureB and C). This proves that SCWO is effective for co-contaminant treatment along with PFAS destruction. The total PFAS concentrations and the sum of PFOA and PFOS measured in the low-concentration effluent sample (FigureB) and the PFAS-spiked lab sample (FIG. A) were 15.72 ng/L and 1.23 ng/L, respectively, compared to 31.46 and 28.37 ng/L in the absence of co-contaminants. Overall, the destruction efficiency of PFCAs, PFSAs, and PFAS precursors was not affected by the presence of co-contaminants (Figure and Table 5). This confirms that complexity of the feed stream does not alter the destruction efficiency of PFAS, and the results demonstrate effective destruction of co-contaminants in the PFAS-impacted IDW streams. The effluent vapor was similarly analyzed for PFAS. This analysis yielded no detectable levels of any of the 24 target PFAS, confirming that the influent compounds are being destroyed rather than escaping the system as a gas.

The individually detectable co-contaminants were found to decrease to undetectable levels in both the low- and high-concentration spiked samples (FigureB and C), and all target organic compounds (and TOC when detected) decreased. This is an expected result as SCWO processes are not specific to breaking carbon-fluorine bonds. Carbon-carbon bonds are also expected to oxidize under the operating conditions of the PFAS Annihilator™.

### Demonstration on an AFFF-Impacted IDW Sample

As yet another proof of concept demonstration, an AFFF-impacted IDW sample was run through the PFAS Annihilator™. The field-collected sample with an initial total target PFAS concentration of 4.9 ppm was run directly through the SCWO reactor without any preprocessing, and a similar destruction efficiency of PFAS was achieved as the laboratory PFAS-spiked sample (FIG. D). The resultant effluent total PFAS concentration was 10.2 ppt and the sum of PFOA and PFOS measured at 1.5 ppt showing six orders of magnitude reduction in PFAS (Table S6), demonstrating the PFAS Annihilator™ as a viable technology to destroy high concentrations of PFAS in AFFF-impacted IDW. Although there was a slight increase in the measured concentration of two VOCs from the influent to the effluent, both concentrations are below the method quantitation limit and may not be accurate. Another interesting finding was a decrease in dissolved fluoride as the field sample passed through the reactor (Table 5). This may be associated with the dramatic change in ion solubilities as water transitions from the sub to supercritical state. Methods to collect this precipitating material are underway and will allow further evaluation of this hypothesis.

In all trials (PFAS spiked, PFAS and co-contaminants spiked, and field samples), PFCA, PFSA, and PFAS precursors/intermediates show a similar level of destruction regardless of the complexity of the feed (Figure A-D). The total summation of measured PFAS concentration in effluent samples in each of the laboratory and field samples was ≤75 ppt (ng/L) with no individual PFAS analyte concentration remaining higher than 70 ppt for any collected effluent sample. The influent and effluent PFAS concentrations for each of the samples presented in Figure are tabulated in Table 5, which highlights the similarities in the effluent PFAS concentration that are achieved by the PFAS Annihilator™ from disparate inlet samples, demonstrating that the complexity of the feed stream does not alter the destruction of PFCAs, PFSAs, PFAS precursors/intermediates, or organic co-contaminants.

Although no pretreatment was required for any of the tested samples and no clogging was observed in these tests, the underlying tubular reactor may be prone to clogging from samples with high concentrations of dissolved solids. The built-in pressure and flow monitors would have deviated from their steady-state operational conditions if appreciable build up were occurring. During long-term operations, processing much larger samples for weeks at a time, the potential reactor clogging could be mitigated with the use of inline devices (e.g., a supercritical salt trap) or modified reactor designs to remove salts and other compounds that precipitate out of solution at supercritical conditions.

### Identification of Byproducts

Aqueous influent, effluent, and equipment blanks, and gaseous effluents (methanol extracts of C18 cartridges and impinger) were investigated for transformation byproducts using LC-qToF/MS analysis. Greater than 99% destruction of PFOA and PFOS was achieved in the effluent, hence no longer chain PFAS were detected in the samples analyzed.

Some unidentified short-chain byproducts were formed and found to elute early on the total ion chromatography (TIC) chromatogram. These are very low-level findings relative to the targeted compounds, which were unquantifiable without analytical standards and were not consistently seen on every run. These data suggest that SCWO completely destroyed PFAS, instead of partial mineralization, which agrees with our previous data from the liquid effluents and reactor surfaces.

### Environmental Implications

The PFAS Annihilator™ tested here is demonstrated as a promising technology for the destruction of PFAS and other common co-contaminants typically found at AFFF-impacted fire training sites. This research presents optimization of the reaction conditions for the complete destruction of PFAS. The oxidant type (O₂ and H₂O₂), temperature (450-625° C.), flowrate (60-190 mL/min), and time to reach steady-state conditions were studied. The best operating conditions (≥600° C. and ≤100 mL/min or 625° C. and ≤140 mL/min) using H₂O₂ as the oxidant destroyed PFAS in laboratory-spiked solutions with initial concentrations ranging from 5 to 50 ppm to below 70 ppt levels in the resultant effluent. The optimized technology was then applied to three inlet sources (PFAS spiked with and without co-contaminants and a field sample) where it successfully reduced PFAS of different chemistries, chain lengths, and precursor presence by up to 6 orders of magnitude. This preliminary data and the impact of operational changes is valuable in upscaling SCWO systems for the destruction of PFAS in contaminated sources for environmental remediation. These data suggest that the destruction of PFAS using SCWO is independent of the oxygen source used in the reactor and that higher temperatures can be used to maintain destruction efficiency while increasing throughput.

Many technologies for the treatment of PFAS-impacted IDW rely on separation techniques, which transfer PFAS from one media to another and therefore generate PFAS-concentrated secondary waste streams (e.g., sorbents and ion exchange regenerated solvent concentrate, reverse osmosis reject, nanofiltration) that require further treatment or disposal. Incineration poses several challenges such as off-site transportation, concerns on the incomplete combustion of byproducts, high energy requirements, immediate release of combustion products into the environment, and cost of operation. See Stoiber, et al. “Disposal of products and materials containing per- and polyfluoroalkyl substances (PFAS): A cyclical problem,” Chemosphere 260 (2020). As no destruction methods are readily available for the long-term effective management of PFAS-impacted IDW and these secondary waste streams, SCWO provides an effective approach. SCWO is an energy intensive process, but much of the expended energy can be recaptured through heat exchangers in a well-designed system. SCWO is also not appropriate for thick slurries (>50% solids) as they do not pump well through a reactor. The SCWO process demonstrated here is capable of directly processing a PFAS-impacted field sample, and the effluent can be released to the environment after confirmatory analysis. Further demonstration is on-going to prove pilot- and full-scale field deployments of the PFAS Annihilator™ at AFFF-impacted sites, landfill leachate, as well as the destruction of stockpiled AFFF concentrates.

1. A method of destroying perfluorosulfonic acids (PFSAs) in an aqueous composition, comprising: passing an aqueous composition comprising perfluorosulfonic acids (PFSAs) in a reaction vessel in the presence of an oxidant at a temperature of at least 550° C. and a pressure of at least 3350 psi and a residence time of at least 8 seconds.

2. The method of claim 1 wherein the temperature is at least 575° C.

3. The method of claim 1 wherein the temperature is at least 600° C.

4. The method of claim 1 wherein the pressure is at least 3350 psi.

5. The method of claim 1 wherein the residence time is at least 10 seconds.

6. The method of claim 1 wherein the residence time is in the range of 8 to 50 seconds.

7. The method of claim 1 wherein the reaction vessel has walls comprising a nickel alloy.

8. The method of claim 1 wherein the temperature is in the range of 550° C. to 650° C.

9. The method of claim 1 wherein the oxidant comprises H₂O₂.

10. The method of claim 1 wherein greater than 95% of the perfluorosulfonic acids are destroyed by the method.

11. The method of claim 1 wherein greater than 99% of the perfluorosulfonic acids are destroyed by the method.

12. (canceled)

13. The method of claim 1 wherein the amount of perfluorosulfonic acids in the aqueous composition are reduced at least 1000 fold by the method.

14. The method of claim 1 wherein the amount of perfluorosulfonic acids in the aqueous composition are reduced at least 10,000 fold by the method.

15. The method of claim 1 wherein the method reduces the amount of organofluorine compounds to below 70 parts per trillion.

16. The method of claim 1 wherein the perfluorosulfonic acids comprise PFOS.

17. The method of claim 1 wherein the method reduces the amount of organofluorine compounds by at least 10,000 fold.

18. The method of claim 1 wherein the method reduces the amount of organofluorine compounds by 10,000 fold to 100,000 fold.

19. The method of claim 1 wherein the method reduces the amount of organofluorine compounds by 100 fold to 10,000 fold.

20. The method of claim 1 wherein the aqueous composition comprises at least 100 ppm of perfluorinated sulfonates and the method decreases the perfluorinated sulfonates concentration by at least 10³ or 10⁶ or 10⁸, and up to about 10⁹.

21. The method of claim 1 wherein the aqueous composition comprises at least 0.5 ppm of perfluorinated sulfonates and the method decreases the perfluorinated sulfonates concentration by at least 10³.

22. The method of claim 1 wherein the aqueous composition comprises at least 0.5 ppm to 300 ppm of perfluorinated sulfonates and the method decreases the perfluorinated sulfonates concentration by at least 10³ or 10⁶ or 10⁸, and up to 10⁹.
